(19) United States
(12) Patent Application Publication
(10) Pub. No.: US 2009/0112709 A1
(43) Pub. Date: Apr. 30, 2009

(54) Mobile Value Transfer System

(76) Inventors: William J. Barhydt, Los Gatos, CA (US); Sanjeev Bhalla, Sunnyvale, CA (US); Jiawen Su, Sunnyvale, CA (US)

Correspondence Address: FISH & RICHARDSON P.C., P.O. BOX 1022, MINNEAPOLIS, MN, 55440-1022, US

(21) Appl. No.: 11/926,753

(22) Filed: Oct. 29, 2007

(51) Int. Cl. G06Q 40/00

(52) U.S. Cl. 705/14; 705/1; 705/39

(57) ABSTRACT

The present invention provides for a financial value transfer system wherein financial value can be transferred between an account associated with a mobile telephone user and a stored value card. The transfer is facilitated using an interface on a mobile telecommunications device, thereby providing greater flexibility with the use of stored value cards

### TECHNICAL FIELD

The present invention generally relates to stored value card value transfer systems.

### BACKGROUND

Stored value cards, such as gift cards and prepaid cards are increasingly popular with merchants and consumers alike. Stored value cards represent money, credit, or other valued interest on deposit with the issuer of the card. To date, stored valued cards can only be accessed, activated, managed, and used through a merchant operated point-of-sale terminal. Moreover, there is no convenient mechanism to transfer funds to or from a stored value card, or centrally manage multiple stored value cards. As such a need exists for a user friendly system and methods to provide greater access to and user flexibility with stored value cards.

### SUMMARY

The present invention addresses this need by providing a system and method of managing stored value cards using mobile telecommunications devices. In particular, the invention comprises a method of accessing a first user account associated with a mobile telephone user, wherein the first user account maintains a financial value; providing a stored value card identification number to the first user account; and transferring a value from the first user account to a second account associated with the stored value identification number.

The present invention is also directed to a method of accessing a stored value card account maintained by a stored value card issuer using a mobile telecommunications device. The mobile telecommunications device user can activate a stored value card and transfer funds to and from a stored value card using an interface on the mobile telecommunications device.

The present invention is further directed to the maintenance of a user account from which financial value can be transferred to and from stored value cards.

The present invention is still further directed to a method of transferring financial value between two accounts associated with one or more mobile telephone users.

The present invention is also directed to a system comprising a mobile telecommunications device, a mobile telephone user account server, a stored value account server, and a mobile value transfer application operative to transfer value to and from a mobile telephone user account to a stored value card.

### BRIEF DESCRIPTION OF THE DRAWINGS

During account registration a password can be created. This password needs to be sent on first request sent server. The server implements a session mechanism where the session is maintained so the password does not have to be supplied on each command. If no request is received for a certain time duration from the user then the session is closed and user either send the password on new request or the system can the user to send the password.]

FIG. 1 illustrates a user interface for accessing a mobile value transfer system;

FIG. 1A illustrates another user interface for accessing a mobile value transfer system;

FIG. 2 illustrates a user interface for registering a stored value card;

FIG. 3 illustrates a user interface for activating a stored value card

FIG. 4. illustrates a user interface for transferring funds associated with a stored value card

FIG. 5. illustrates a user interface for managing stored value cards;

FIG. 6 illustrates a user interface for transferring finds associated with a stored value card;

FIG. 7 illustrates another user interface for transferring finds associated with a stored value card;

FIG. 8 illustrates a user interface for accessing a mobile value transfer system;

FIG. 9 illustrates a user interface confirming the transfer of finds associated with a stored value card;

FIG. 10 illustrates a user interface for transferring funds to a mobile value transfer account;

FIG. 11 illustrates another user interface for transferring funds to a mobile value transfer account;

FIG. 12 illustrates another user interface for transferring finds to a mobile value transfer account;

FIG. 13 illustrates a user interface confirming the transfer of funds to a mobile value transfer account;

FIG. 14 illustrates a user interface for transferring funds between two mobile value transfer accounts;

FIG. 15 illustrates another user interface for transferring funds between two mobile value transfer accounts;

FIG. 16 illustrates a user interface informing a third party of a desired funds transfer between two mobile value transfer accounts;

FIG. 17 illustrates a user interface confirming the transfer of funds between two mobile value transfer accounts;

FIG. 18 is a block diagram of a communications system that includes mobile telecommunications devices, a wireless network infrastructure, and a mobile value transfer system server; and

FIG. 19 is a flow chart of a process for transferring funds associated with a stored value card.

### DETAILED DESCRIPTION

Stored value cards, such as gift cards, pre-paid cards, and plan cards, offer a convenient alternative to traditional gift certificates, vendor discount plans, and consumer account plans. Stored value cards can be purchased in various values, and are good at various shopping, dining, and entertainment establishments.

A stored-value card represents money on deposit with the issuer, typically a retailer or service provider, and is similar to a debit card. Stored value cards, however, are usually issued anonymously with the value associated with a specific card identified by a card number and maintained on a computer affiliated with the card issuer. Debit cards, on the other hand, are typically issued in the name of individual account holders. Stored value card issuers profit from the interest that is earned between the time of purchase and the time of use. Stored value cards are sometimes referred to as “closed loop” cards as they typically can only be used at the merchant who issued the card. Stored value cards can also be issued by service providers, such as credit card companies, financial, educational, or research institutions, professional organizations, or employers. In such cases, an issued stored value card may be used at multiple participating merchants. Stored value cards can be single use or rechargeable, meaning that funds, credit or other value may be deposited to the card.

Stored value cards have been used at retail locations such as department stores, drug stores, restaurants and boutiques. Stored value cards have also been used with student accounts at educational facilities, employee accounts at employer and research campuses, by public transit systems, amusement parks, expositions and trade shows, resorts, and various organizations sharing a common interest such as merchant groups, professional and trade organizations, and the like.

In operation, the value associated with a specific stored value card can be accessed using a magnetic stripe embedded on the card and encoded with the unique card number or other unique card identifier. Radio-frequency identification (RFID) or a code number printed on the face of the card may also be used to identify a specific stored value card. A point-of-sale (“POS”) terminal processes the card number and accesses a computer system maintaining the value associated with the specific card number. Consumers may activate the card, check card balance, and use the card to make purchases at merchant locations having the POS terminal.

Because stored value cards are limited to funds associated with a specific card, there has been no mechanism to conveniently access, manage, and recharge card values without physically bringing the card to a participating merchant having a POS terminal. Additionally, stored value cards have not allowed the transfer of funds between cards issued from different sponsors or issuing merchants. As such, a need exists for a remote system and method through which the consumer can access stored value cards, manage account balances and transfer to and from stored value cards without the use of the merchant POS terminal.

It has been found that mobile telecommunication devices, such as cellular telephones and personal data assistants offer a convenient platform from which consumers and stored value card users can easily and conveniently manage stored value cards. For example, in an implementation a user can activate, manage, and deposit funds to or from a stored value card using a mobile telecommunications device. Additionally, consumers can transfer funds from one stored value card to another, or even from one consumer account to another consumer account.

Mobile telecommunications devices provide nearly instantaneous access to valuable and relevant information beyond simple voice communications. E-mail, web access, and messaging services such as SMS (“Short Message Service”) and/or MMS Multimedia Messaging Service”) are available on nearly all mobile devices. At the same time mobile devices have an unmatched consumer penetration rate, often reaching 70-80% of a nation's population—significantly higher than other media forms. Using a mobile value transfer application as further described herein, a user can obtain a stored value card, for example as a gift or at a local retail store. The user can then activate the stored value card remotely—without the use of the retailer POS terminal—by registering the stored value card with a mobile value transfer application. Registration allows the user not only to activate the card, but also to access the account balance on the registered stored value card, access the account balance associated with the mobile value transfer account particular to the user, transfer funds from the mobile stored value account to the stored value card, transfer funds from the stored value card to the mobile stored value account particular to the user, and transfer funds to a different user's stored value account. These and other transactions will be described in greater detail below.

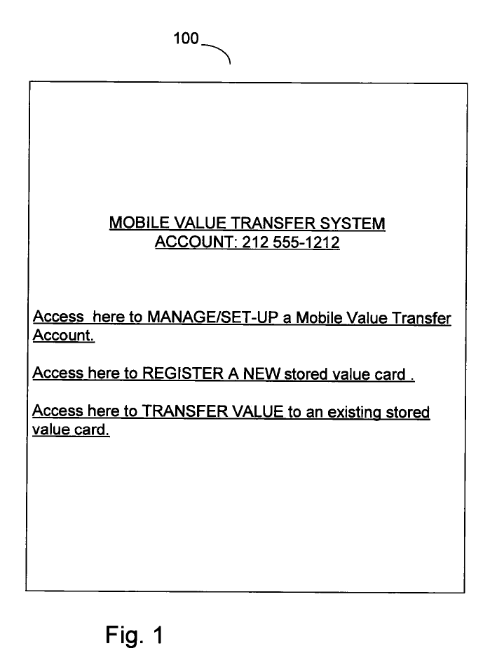

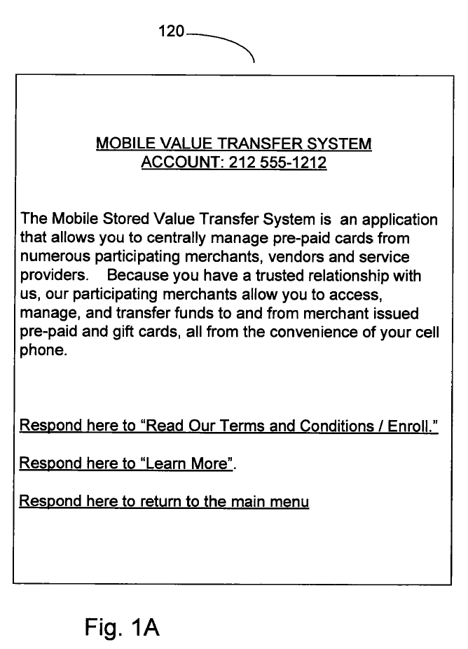

As is shown in user interface (“UI”) 100 in FIG. 1, a user prompt is displayed on a mobile value transfer application associated with user account 212 555-1212. Mobile value transfer application maintains a user account associated with individual users. The account may be identified by a mobile telephone number or other unique identifier. UI 100 prompts the user to access a user account management/set-up function, register a new card, or to transfer value to an already registered card. UI 20 in FIG. 1A depicts an exemplary interface inviting an unregistered user to enroll in the Mobile Stored Value Transfer System. In an implementation, upon registration or user login to a user account, a session is established. This may be implemented using a password in addition to an account identifier. The server implements a session mechanism where the session is maintained so the password does not have to be supplied on each command. If no request is received for a certain time duration from the user then the session is closed and user either send the password on new request or the system can challenge the user to send the password.

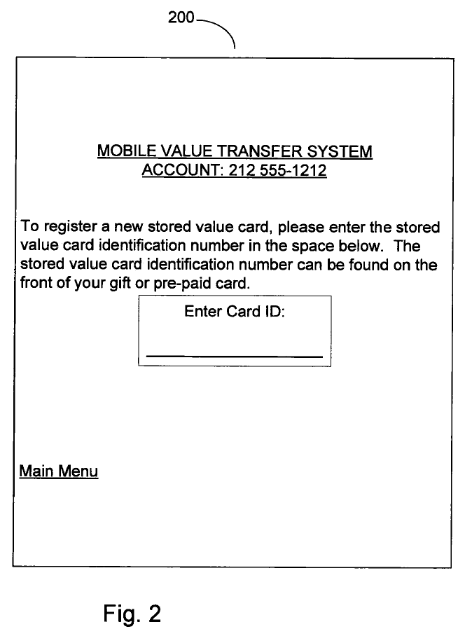

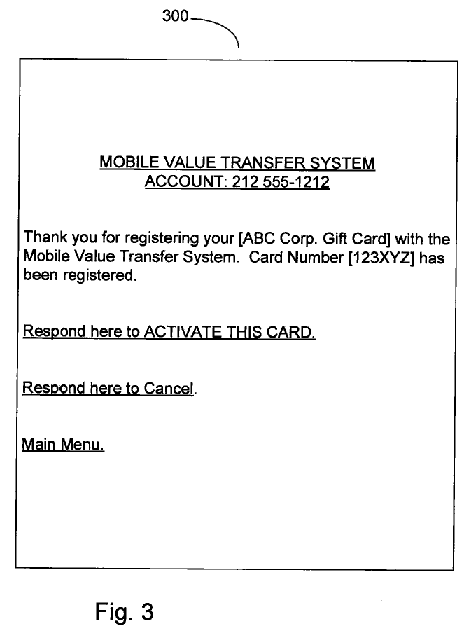

UI 200 in FIG. 2 prompts the user to register a stored value card by entering the stored value card number printed on the face of the stored value card. Upon registration the specific stored value card registered by the user is associated with the user account 212 555-1212 and the stored value card balance is recorded in the mobile value transfer system. UI 300 in FIG. 3 confirms registration of the stored value card number “XYZ123” and prompts the user to activate stored value card “XYZ123” with the issuing sponsor. In one implementation the mobile value transfer system associates the stored value card number with the brand name of the issue sponsor and prompts the user for activation with the issuing sponsor, “ABC Corp.”

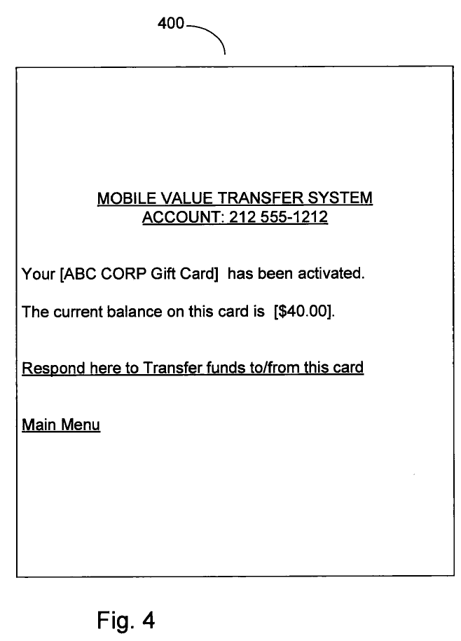

After registration of stored value card number “XYZ123” with the mobile value transfer system and activation of stored value card number “XYZ123” with the issuing sponsor “ABC Corp.,” UI 400 in FIG. 4 confirms activation of the stored value card and displays the balance associated with the registered and activated stored value card. The user is also prompted to transfer funds, credit, or value to or from stored value card “XYZ123” to or from mobile value transfer account number “212 555-1212,” the account number associated with the user. The user may also exit the mobile value transfer system. In an implementation, registration of the stored value card with the mobile value transfer system and activation with the stored value card issuing sponsor can be accomplished simultaneously as one user prompt.

The transfer of funds to the stored value card from the mobile value transfer system will now be described.

In an exemplary implementation a user interface is provided through which a user accesses a mobile value transfer system, queries an account balance for an account associated with the user, chooses to transfer funds, credit, monetary value, or the like from the user account to a specified pre-registered stored value card, and receives confirmation of the transferred value to the specified pre-registered stored value card. As previously discussed, UI 100 in FIG. 1 prompts a user to access a user account management/set-up function, register a new stored value card, or to transfer funds to an already registered stored value card.

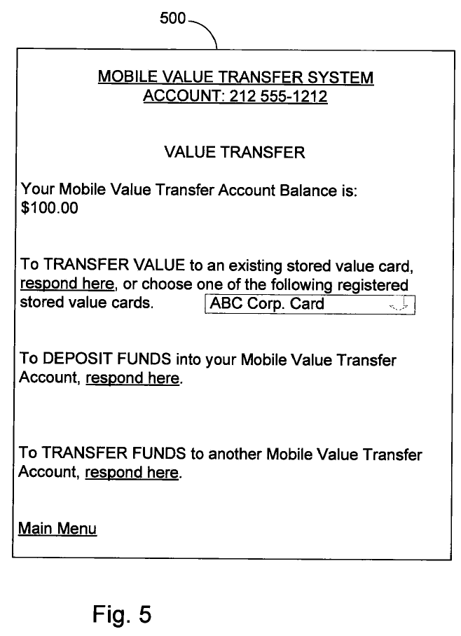

Upon choosing the transfer option UI 500 in FIG. 5, indicates an account balance associated with mobile value transfer account number “212 555-1212” and prompts the user to transfer funds, credits, or other value from mobile value transfer account number “212 555 1212” to an existing registered stored value card. UI 500 can display a menu of existing registered stored value cards as a drop down menu, a menu tree, or the like. Individual pre-registered stored value cards can be displayed by stored value card number or any other unique identifier. Alternatively, the previously registered stored value cards can be displayed in UI 500 by the issuer's brand identity, icon, or mark; by a product name or mark associated with the stored value card issue; or by a label or icon chosen by the user.

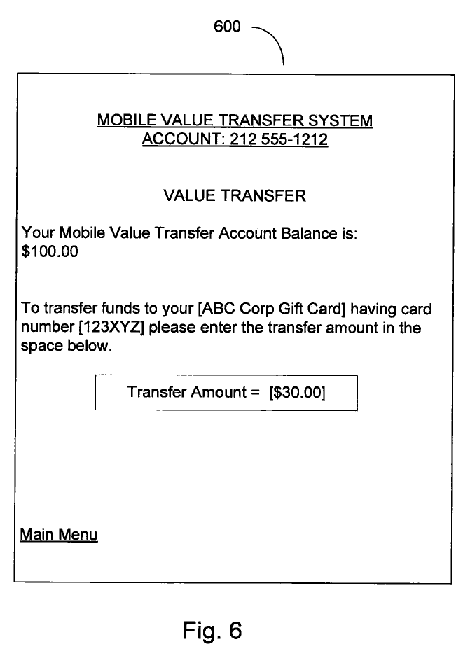

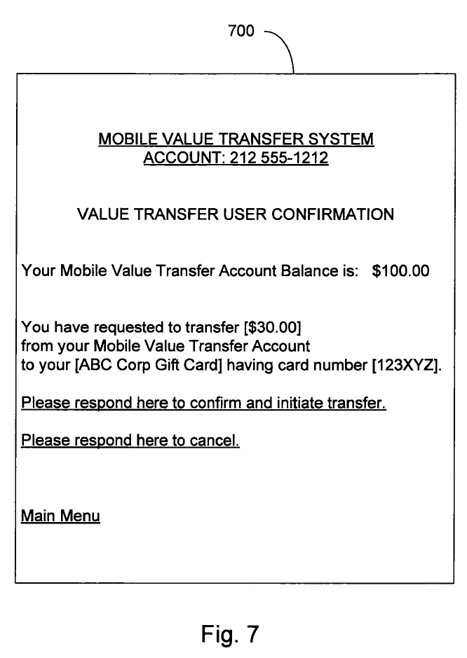

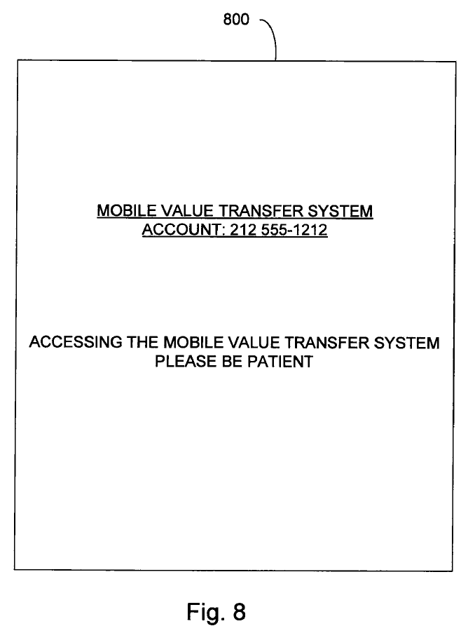

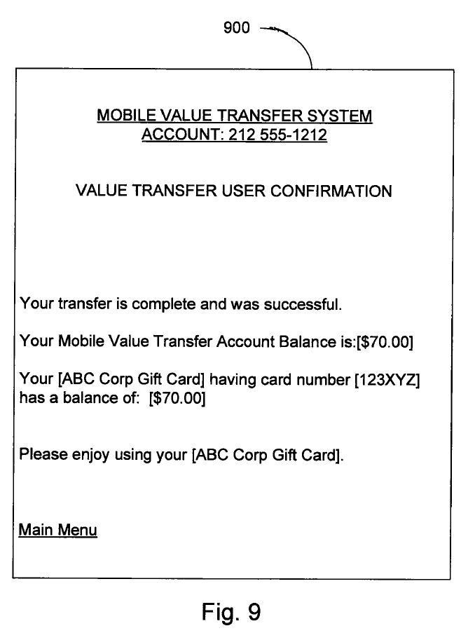

After selecting the desired stored value card chosen in UI 500, such as “ABC CORP. GIFT CARD,” the user is prompted to enter an amount to transfer from mobile value transfer account number “212 555-1212” to the selected stored value card, as indicated in UI 600 of FIG. 6. UI 700 in FIG. 7 prompts the user to confirm the transfer amount, such as “$40.00.” UI 800 of FIG. 8 informs the user that the mobile value transfer system is being accessed along with any necessary card issuer systems in order to complete the funds transfer. UI 900 in FIG. 9 depicts a confirmation that the selected value was transferred from mobile value transfer account number “212 555-1212” to the pre-registered stored value card associated with stored value card number “XYZ123.”

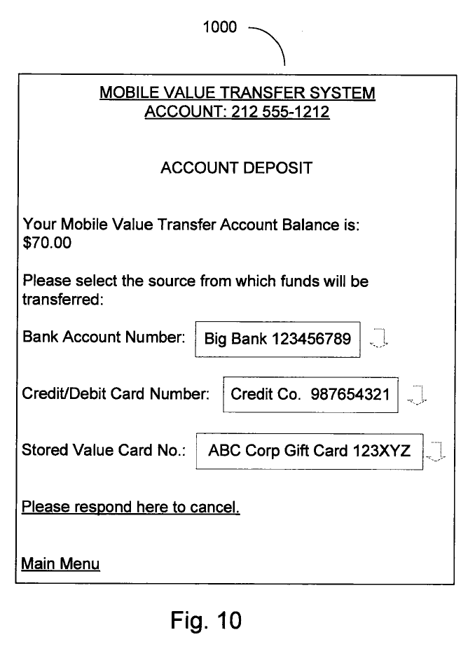

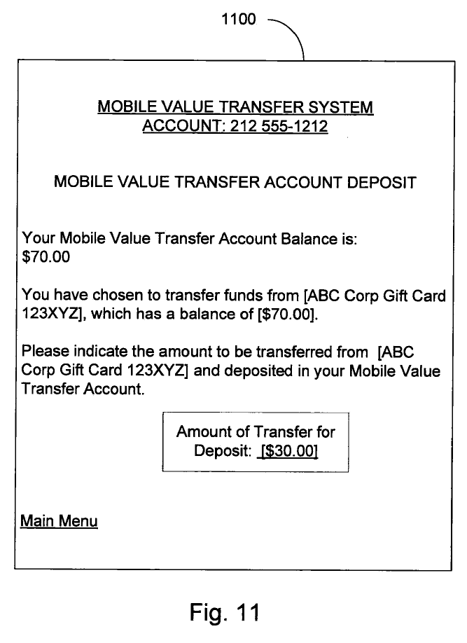

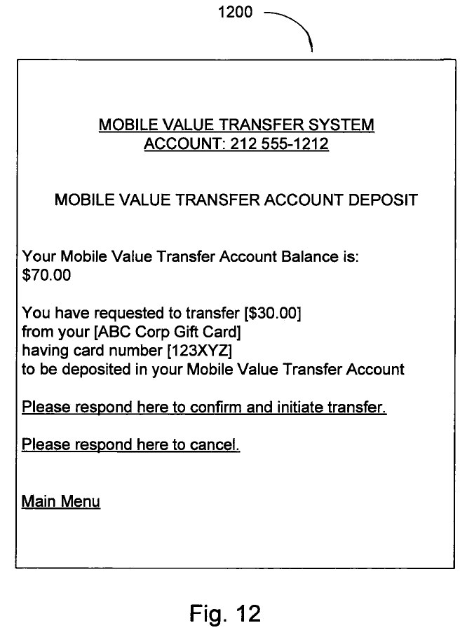

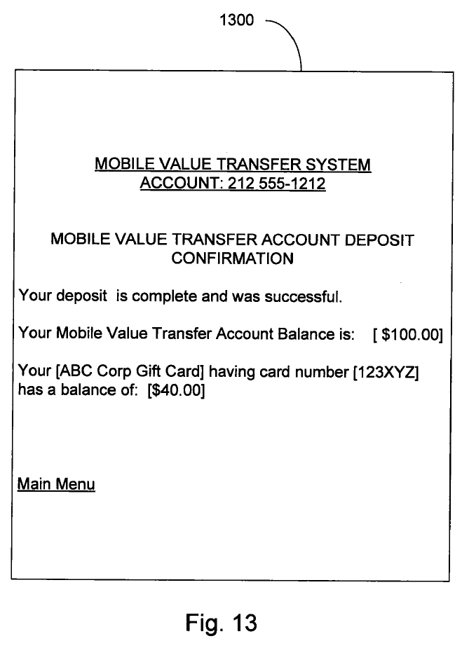

In another implementation, funds can be deposited to the user's mobile value transfer account from a bank account, credit card, bank card, debit card, or a pre-registered stored value card. Also depicted in UI 500 in FIG. 5 is a user prompt to deposit funds to the mobile value transfer account number. The user can choose the source from which funds are to be transferred to mobile value transfer account number “212 555-1212.” UI 1000 in FIG. 10 depicts three pull down menus from which the user can deposit funds into the user account, including, bank accounts, credit cards, and pre-registered stored value cards. After selecting the deposit source, UI 1100 in FIG. 11 confirms the deposit source, “ABC CORP GIFT CARD”, displays, if applicable, a balance associated with the funding source, “$70.00,” and prompts the user to enter the transfer amount, “$30.00” to be deposited into the mobile value transfer user account, “212 555-1212,” from the selected source, “ABC CORP GIFT CARD.” UI 1200 in FIG. 12 confirms the transfer amount and again confirms source of funds to be transferred. UI 800 in FIG. 8 informs the user that the mobile value transfer system is accessing the necessary systems to transfer from the selected transfer source to the mobile value transfer account number. And UI 1300 in FIG. 13 confirms that the transfer is complete, displays a new balance associated with the transfer source and displays a new balance, “$100.00,” associated with the mobile value transfer account number “212 555-1212.”

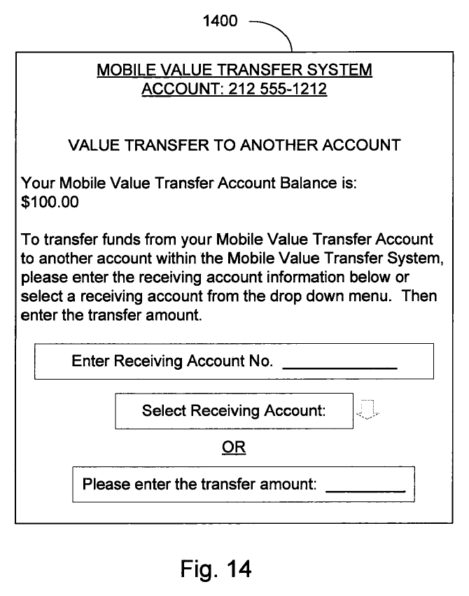

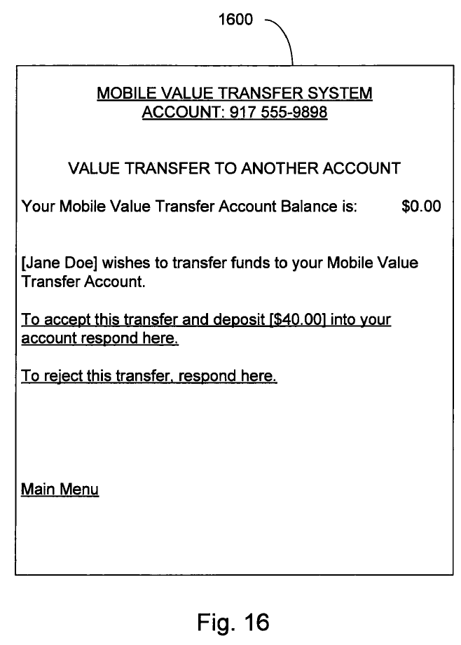

In another implementation, a user can transfer funds from the user's mobile value transfer account to a second mobile value transfer account. The second mobile value transfer account may be associated with the same user or with a different user. Also depicted in UI 500 in FIG. 5 is a user prompt to transfer funds between mobile value transfer account numbers. UI 1400 in FIG. 14 prompts the user to select or enter the mobile value transfer account that will receive the transferred funds. The user may enter the receiving mobile value transfer account directly or choose from a predetermined list of mobile value transfer account numbers, for example, account numbers associated with friends, family, or frequently accessed accounts. The mobile value transfer account numbers listed in the predetermined list of accounts may be identified by account number, any other unique identifier, or an alias assigned by the user, such as “MY SON’S ACCOUNT.” UI 1400 also prompts the user to enter the transfer amount, such as “$40.00.” UI 1500 in FIG. 16 confirms the transfer amount “$40.00” and receiving account information, which can be identified by a user assigned alias, such as “MY SON'S ACCOUNT” and/or a Mobile value transfer account number, such as “917 555-9898.” Upon user confirmation UI 800 in FIG. 8 informs the user that the mobile value transfer system is accessing the necessary systems to transfer from the user's mobile value transfer account to the specified receiving mobile value transfer account.

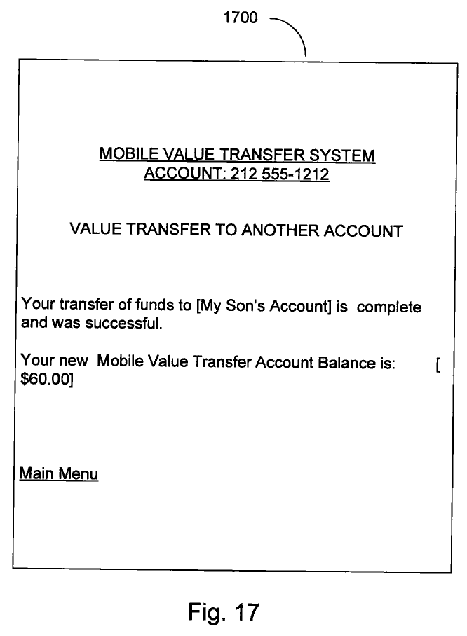

UI 1600 in FIG. 16 informs the user associated with the receiving account that a transfer is desired and prompts the receiving user to accept or deny the transfer. Once the transfer is accepted by the receiving user, UI 17 in FIG. 17 confirms the transfer.

It will be appreciated that the various UI's discussed above may be implemented as a graphic user interface (“GUI”) application residing on the mobile telecommunication device. Alternatively, one or more UI's may be implemented using a standard Short Message Service (“SMS”) or Multimedia Message Service (“MMS”). Additionally, one or more UI's can be implemented using a Wireless Application Protocol (“WAP”) interface.

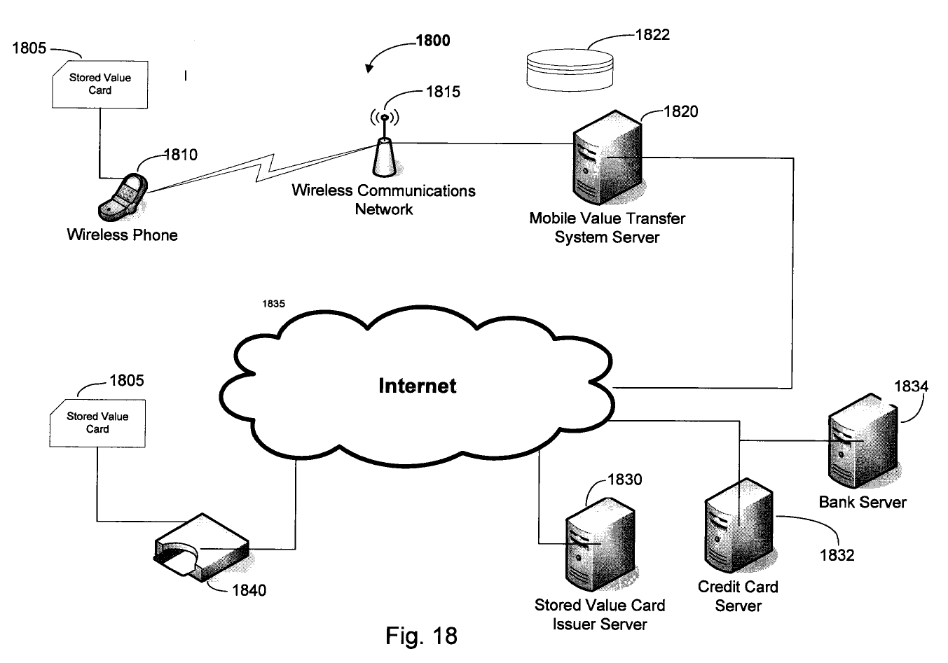

FIG. 18 illustrates an exemplary system architecture for providing an implementation of a mobile value transfer system 1800, including one or more stored value cards 1805, one or more mobile telecommunications devices, such as mobile telephone 1810, in communication with a mobile value transfer system server 1820 via a wireless telecommunications network 1815. Mobile value transfer system server 1820 includes a processor coupled to a computer readable memory, wherein the memory includes mobile value transfer application 1825. Mobile value transfer system server 1820 can include one or more secondary storage devices, such as database 1822. Mobile value transfer system server 1820 is also in communication with one or more stored value card provider servers 1830 via a network, such as the Internet 1835. Stored value card provider servers 1830 are in communication with one or more merchant point-of-sale terminals 1840 for reading and using stored value card 1805.

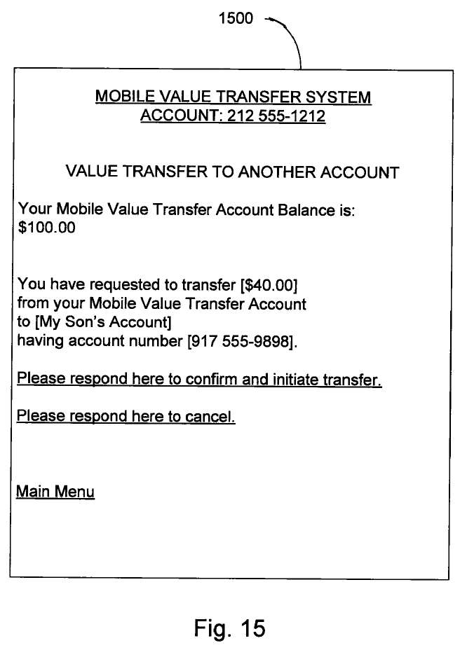

Mobile telephone 1810 is configured to interface with a wireless infrastructure, such as wireless telecommunications network 1815. Generally, mobile telephone 1810 displays one or more user interfaces (e.g., the UI's described previously in FIGS. 1-17) to activate and transfer value to/from stored value cards using a mobile value transfer account. Generally mobile telephone 1810 includes one or more devices capable of accessing wireless telecommunications network 1815 to exchange communications. Mobile telephone 1810 can include a messaging application to support SMS or MMS communications. Mobile telephone 1810 can include an e-mail application. Mobile telephone 1810 can include a web browser and application for accessing the Internet or World Wide Web using a wireless application protocol (“WAP”). Mobile telephone 1810 can include an application for direct communication with mobile value transfer application 1825 maintained on mobile value transfer system server 1820.

The mobile value transfer system server 1820 maintains information related to individual mobile value transfer accounts associated with specific users. Such accounts also include information relating to: stored value cards associated with the mobile value transfer account; various account and stored value card balances; metrics associated with various accounts and stored value cards, such as purchasing profiles, usage rates, and the like; and as well as user demographics and information for the mobile stored value account owner.

In an implementation, user demographics and targeting information is used to place targeted content, such as advertising and marketing content, on the user's mobile handset. The target content can be related to or responsive to user interactions with a stored value card or user account. Moreover, the user can be rewarded for viewing and interacting with targeted content. Mobile content placement rewards systems and methodologies are disclosed in co-pending U.S. patent application Ser. No. ______, (Attorney Docket No. 22573-004001), filed on Oct. 29, 2007, and incorporated herein by reference. The targeted content can be imbedded in the mobile value transfer system, for example as part of a user interface for transferring value from a stored value card, or can be part of an SMS or WAP based marketing campaign.

In an implementation, a mobile device user can deposit financial value (i.e., money) into the user's Mobile value transfer account by using a bank account, credit card, pre-paid card, or a stored value card from a participating card issuer. The mobile device user can then deposit funds to recharge a stored value card registered with the mobile value transfer system 1800. In order to recharge, or transfer funds from the mobile device user's mobile value transfer account to a registered stored value card, mobile value transfer system server 1820 communicates with a participating stored value card issuer Server 1830 in order to transfer financial value between the mobile user's mobile value transfer account and the stored value card 1805.

Stored value card 1805 is issued and processed by stored value card issuer server 1830. Upon receiving financial value transfer instructions from mobile value transfer system server 1820, the stored value card issuer server 1830 updates the balance on stored value card 1805. The stored value card owner can then use the stored value card 1805 on point-of-sale system 1840 as is known and appreciated in the art

Mobile value transfer system server 1820 is a computer server system operable for maintaining mobile value transfer accounts for mobile device users in a database. The database can be a relational database. The mobile value transfer accounts are indexed by the mobile user's telephone number or some other unique identifier. Mobile value transfer account server 1820 maintains many user attributes associated with a user account, including a stored value attribute or an account balance. Mobile users may use the stored value attribute to deposit financial value into a registered stored value card or deposit financial value into a second mobile value transfer account. Deposits may similarly be made to a user's mobile value transfer account from a bank account, credit card, debit card, or a stored value card.

For example, in an implementation, a user desiring to deposit funds to the user's stored value account would access the stored value transfer application 1825 using an interface on mobile telephone 1810 (e.g., the interfaces previously described in FIGS. 1-17). The user would choose the source from which funds will be drawn, for example a bank account maintained on bank server 1834, a credit card account maintained on credit card server 1832, or a registered stored value card maintained on stored value card issuer server 1830. Mobile value transfer system server 1820 communicates with the appropriate funding source server, such as bank server 1834, credit card server 1832 or stored value card issuer server 1830 to deposit funds into the mobile value transfer account. Mobile value transfer system server 1820 then communicates via an interface (e.g., the interfaces previously described in FIGS. 1-17) with mobile telephone 1805 that the transaction was completed.

In an implementation wherein the user desires to transfer funds from one mobile value transfer account to a second mobile value transfer account, the user accesses the stored value transfer application 1825 using an interface on mobile telephone 1810 (e.g., the interfaces previously described in FIGS. 1-17). The user would choose a second mobile value transfer account to receive funds from the user's first mobile value transfer account. The second mobile value transfer account can be associated with the user or can be associated with a different user. Mobile value transfer system server 1820 then communicates with mobile telephone 1805 using an interface (e.g., the interfaces previously described in FIGS. 1-17) to confirm the recipient of the funds transfer desires to complete the transaction. Mobile value transfer system server 1820 then communicates with mobile telephone 1805 using an interface (e.g., the interfaces previously described in FIGS. 1-17) to confirm that the transaction was successful or was denied by the recipient.

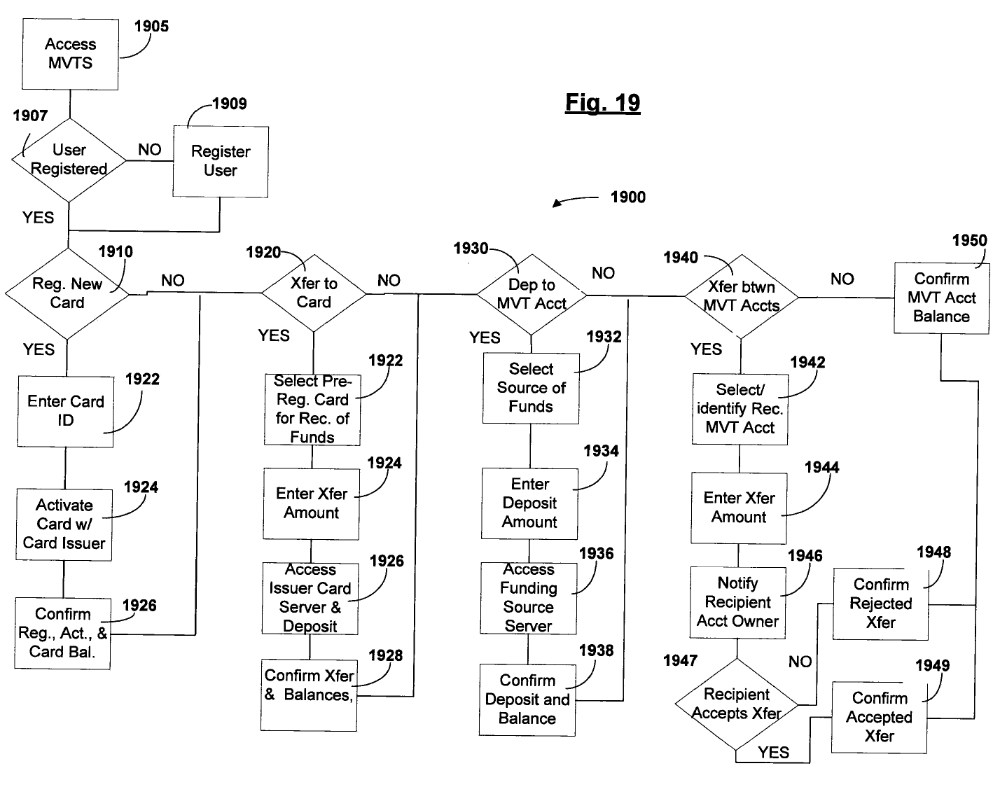

FIG. 19 is a flow chart 1900 of a process by which a mobile telephone user registers a stored value card with a mobile value transfer system, activates the stored value card with the stored value card issuer, transfers financial value to the stored value card from a mobile value transfer account on a mobile value transfer system, deposits funds to a mobile stored value account, and/or transfers funds between mobile stored value accounts.

Initially, a mobile telephone user accesses 1905 the mobile value transfer system. The mobile value transfer system can query 1807 the user to determine if the user is registered and has a mobile value transfer account. If the user in not registered, the mobile value transfer system can register the user 1909 and create a mobile value transfer account. It will be appreciated that during the registration process the various user profile, demographic and financial services information (e.g., age, sex, income, credit card number, bank accounts, preferred interests, preferred merchants, etc.) can be captured and stored for use with the user's mobile value transfer account.

A registered user is then queried to determine if the user desires to register a new stored value card 1910, transfer financial value to a registered stored value card 1 920, deposit financial value to the user's mobile value transfer account 1930, or transfer funds between two stored value accounts 1940.

A user desiring to register a new stored value card 1910 inputs the unregistered stored value card identification number 1922 using an interface on the user's mobile telephone (e.g., the interfaces previously described in FIGS. 1-17). The mobile value transfer system then registers 1924 the stored value card identification number with the mobile value transfer system and activates 1924 the stored value card with the stored value card issuer. Registration and activation are confirmed 1926 along with the registered stored value card balance and the user's mobile value transfer account balance using an interface on the user's mobile telephone.

A user desiring to transfer financial value 1920 from the user's mobile value transfer account to a registered stored value card selects 1922 the desired registered stored value card using an interface on the user's mobile telephone (e.g., the interfaces previously described in FIGS. 1-17). The user then enters 1924 the amount to be transferred from the user's mobile value transfer account to the selected stored value card. The mobile value transfer system then accesses 1926 a server, computer system, or other system maintained by the stored value card issuer and deposits the transfer amount entered at 1924 to the stored value card selected at 1922. The financial value transfer is confirmed 1928 along with the new stored value card balance and the user's new mobile value transfer account balance using an interface on the user's mobile telephone.

A user desiring to deposit funds 1930 to the user's mobile value transfer account selects 1922 the source of funds, such as a bank account, credit card account, or registered stored value card, using an interface on the user's mobile telephone (e.g., the interfaces previously described in FIGS. 1-17). The user then enters 1934 the amount to be deposited from the source of finds selected in 1932. The mobile value transfer system then accesses 1936 a server, computer system or some other system maintained by the funding source, such as a server maintained by a bank, credit card company or stored value card issuer, and transfers the financial value amount entered in 1934 from the funding source selected in 1932 to the user's mobile value transfer account maintained by the mobile value transfer system. The deposit is confirmed 1938 along with the user's new mobile value transfer account balance using an interface on the user's mobile telephone.

A user desiring to transfer 1940 financial value between two different mobile value transfer accounts enters 1942 the account identifier for the mobile value transfer account that will receive financial value from the user's mobile value transfer account. The user enters the receiving account identifier, such as the account's associated mobile telephone number using an interface on the user's mobile telephone (e.g., the interfaces previously described in FIGS. 1-17). The user then enters 1934 the amount to be transferred from the user's mobile value transfer account to the mobile value transfer account selected in 1932. The mobile value transfer system then communicates with the recipient account owner via an interface on the owner's mobile telephone to confirm 1947 that the recipient desires to receive the financial value transfer. The mobile value transfer system then confirms with the user initiating the transfer whether the recipient accepted 1949 or rejected 1948 the transfer. The transferring user's mobile value transfer account balance is updated and confirmed 1950.

What is claimed herein is:

1. A method of transferring value in a stored value card, comprising:
accessing a first user account associated with a mobile telephone user, wherein the first user account maintains a financial value;
providing a stored value card identification number to the first user account; and
transferring a value from the first user account to a second account associated with the stored value identification number.

2. The method of claim 1 wherein the second account is maintained by an issuer of the stored value card.

3. The method of claim 1 further comprising:
accessing a first user account with a mobile communication device; and
entering a stored value card identification number via an interface on the mobile communication device.

4. The method of claim 3 wherein the interface is an SMS/MMS, WAP, or GUI interface.

5. The method of claim 1 further comprising:
confirming the value transfer via an interface on a mobile telecommunications device.

6. The method of claim 5 wherein the interface is an SMS/MMS, WAP or GUI interface.

7. The method of claim 1 wherein transferring value adds value to the second account associated with the stored value card identification number.

8. The method of claim 1 wherein transferring value subtracts value from the second account associated with the stored value card identification number.

9. A method of transferring value over a mobile telecommunications network, comprising:
accessing a first user account associated with a mobile telephone user, wherein the first user account maintains a financial value;
identifying a second account, wherein the second account maintains a financial value;
transferring financial value from the first user account to the second account using an interface on a mobile telecommunications device, wherein the second user account is configured to transfer value to or from a stored value card.

10. The method of claim 9 wherein the second account is associated with a mobile telephone user.

11. The method of claim 9 wherein the second account is associated with a mobile telephone user different from the mobile telephone user associated with the first user account.

12. The method of claim 9 further comprising obtaining acceptance of the transfer of value from the mobile telephone user associated with the second account.

13. The method of claim 9 wherein accessing the first user account and identifying a second account are via an interface on a mobile telecommunications device.

14. The method of claim 9 wherein the interface is an SMS/MMS, WAP or GUI interface.

15. The method of claim 9 wherein transferring value subtracts value from the second account and adds value to the first account.

16. The method of claim 9 wherein the second account is associated with a bank account, credit card account, stored value card identification number, or a mobile value transfer account.

17. The method of claim 9 further comprising confirming the value transfer using an interface on a mobile telecommunications device.

18. A method of activating a stored value card comprising:
accessing a first user account associated with a mobile telephone user;
providing a stored value card identification number using an interface on a mobile telecommunications device;
activating the stored value card with the stored value card issuer;
recording activation of the stored value card in the first user account; and
confirming activation of the stored value card via an interface on a mobile telecommunications device.

19. A method of transferring financial value associated with a stored value card, comprising:
obtaining a stored value card having a stored value card identification number;
accessing a first user account associated with a mobile telephone user;
providing the stored value card identification number via an interface on a mobile telecommunications device;
entering a financial value transfer amount using an interface on a mobile telecommunications device;
transferring the entered financial value amount from the first user account to a second account associated with the stored value card identification number; and
confirming the transfer of financial value using an interface on a mobile telecommunications device.

20. The method of claim 19 wherein the transfer of financial value subtracts value from the second account and adds value to the first user account.

21. A system for transferring value associated with a stored value card comprising:
a first server operative to maintain a stored value card account associated with a stored value card identification number;
a second server in communication over a network with the first server and operative to maintain a mobile value transfer account associated with a mobile telephone number;
a mobile telecommunications device having an interface for communicating with the second server wherein the mobile telecommunications device communicates over a mobile telecommunications network; and
a mobile value transfer application configured to receive a stored value card identification number from the mobile telecommunications device and transfer financial value between the second server and the first server.

22. The system of claim 21 further comprising:
a third server in communication with the second server and operative to maintain a financial value account; and
a mobile value transfer application configured to receive information identifying the financial value account entered in an interface on the mobile telecommunications device and transfer financial value between the third server and the first server.

23. A method of transferring value in a stored value card, comprising:
accessing a first user account associated with a mobile telephone user, wherein the first user account maintains a financial value;
providing a stored value card identification number to the first user account;
transferring a value from the first user account to a second account associated with the stored value identification number; and
depositing a reward value to the first account.

24. A method of transferring value in a stored value card, comprising:
accessing a first user account associated with a mobile telephone user, wherein the first user account maintains a financial value;
providing a stored value card identification number to the first user account;
transferring a value from the first user account to a second account associated with the stored value identification number; and
inserting content to a mobile device associated with the first mobile telephone user.
